(19) United States
(12) Patent Application Publication
(10) Pub. No.: US 2005/0111478 A1
(43) Pub. Date: May 26, 2005

(54) Distributed control load shaping method and apparatus

(75) Inventors: Jeffrey Douglas Brown, Rochester, MN (US); Michael Norman Day, Round Rock, TX (US); Charles Ray Johns, Austin, TX (US); Thuong Quang Truong, Austin, TX (US); Takeshi Yamazaki, Austin, TX (US)

Correspondence Address: IBM CORPORATION (CS);C/O CARR LLP, 670 FOUNDERS SQUARE, 900 JACKSON STREET, DALLAS, TX, 75202, US

(73) Assignees: International Business Machines Corporation, Armonk, NY (US); Sony Computer Entertainment Inc., Tokyo (JP)

(21) Appl. No.: 10/718,936

(22) Filed: Nov. 20, 2003

(51) Int. Cl. H04L 12/42

(52) U.S. Cl. 370/451

(57) ABSTRACT

Disclosed is an apparatus for controlling or managing the transmission of data packets over a multiplexed communication path, referred to herein as a bus, on a priority basis up to a given authorized BW (Bandwidth), in a given operational time period, for presently authorized devices or applications. Non-managed (not presently authorized) bus requests are handled in a prior art “best effort” basis.

### CROSS-REFERENCED APPLICATIONS

This application relates to co-pending U.S. patent applications entitled “Centralized Bandwidth Management Method and Apparatus” (Docket No. AUS920030611US1) in the names of Jeffrey Douglas Brown, Scott Douglas Clark, and John David Irish, filed on Sep. 30, 2003, and “Controlling Bandwidth Reservations Method and Apparatus” (Docket No. AUS920030613US1) in the names of Charles Ray Johns, Matthew Edward King, Peichun Peter Liu, David Mui, and Jieming Oi, filed concurrently herewith.

### TECHNICAL FIELD

The invention relates to allocating BW (Bandwidth) and governing access to a bus by competing devices.

### BACKGROUND

Normally, when a plurality of programs or applications on a single computer need to use the bus at the same time, each program is granted less bandwidth than it would prefer to use.

In many computers, the OS (Operating System) can be instructed to give priority to some programs and require others to operate in the background. However, if too many of the priority programs require access to the bus, one or more of the priority programs will have to operate at a less than desirable speed. Although such a slowdown situation may be tolerable for some programs, such as word processors, they may be completely unacceptable in a situation where a game, video or other high bandwidth program is being utilized. Inadequate bandwidth, in such a situation, may result in a distorted display, stilted motion or some other similar, and less than desirable, end result.

When the environment is more complex and a plurality of processors and other intelligent entities or devices must access the same bus, the BW (Bandwidth) problem is compounded.

It would be desirable to find a simple method of controlling or governing access to the bus whereby high priority programs are assured of having the BW they need to operate properly.

### SUMMARY OF THE INVENTION

The present invention comprises using a shaper or governing type control mechanism for assigning time slots on a distributed basis over a given time period to a given managed application for a length of time adequate to perform a task while permitting unmanaged applications to use unassigned time slots.

### BRIEF DESCRIPTION OF THE DRAWINGS

For a more complete understanding of the present invention, and its advantages, reference will now be made in the following Detailed Description to the accompanying drawings, in which:

FIG. 1 is a block diagram of a plurality of network interconnected computers or PUs (Processing Units) including external devices supplying inputs thereto or receiving data therefrom;

FIG. 2 is a flow diagram of the steps that some authority, such as the OS (Operating System) utilized in FIG. 1, may take in determining whether or not to grant an entity a managed time slot on a common network; and

FIG. 3 is a flow diagram used by a bus request management device in determining bus access for a given bus request.

### DETAILED DESCRIPTION

In the remainder of this description, a processing unit (PU) may be a sole processor of computations in a device. In such a situation, the PU is typically referred to as a CPU (Central Processing Unit). In multiprocessor systems, one or more PUs may be utilized as a central or main control unit for the purpose of distributing tasks to other PUs. However, in the remainder of this document, all processing units will be referred to as PUs.

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

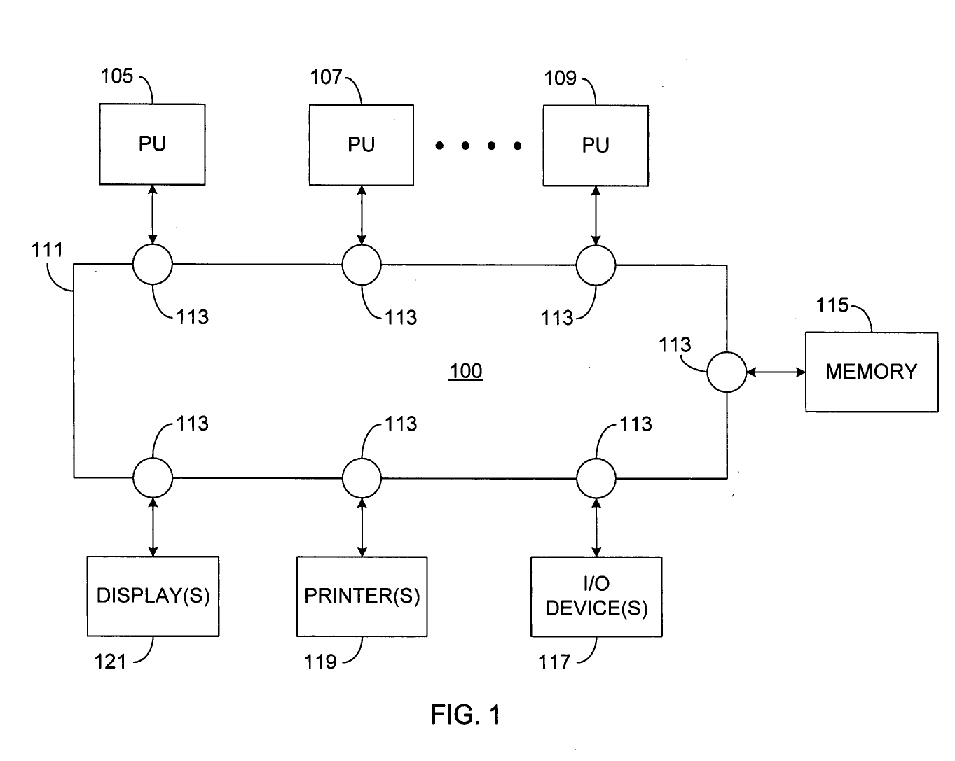

In FIG. 1, a multiprocessor system is shown with a plurality of PUs. Three of the PUs are designated 105, 107 and 109. The dots between PUs 107 and 109 are an indication that many more PUs are typically located between PUs 107 and 109. Each of the PUs is interconnected to a bus 111 via a bus request queue manager 113. Likewise, a memory block 115 is connected to the bus 111 via bus request queue manager 113. In similar fashion, other devices, such as one or more I/O (input/output) devices 117, one or more printers 119 and one or more displays 121 may also be connected to the bus 111 by bus request queue managers 113. It may be noted that present day printers and displays are generally not considered to be bus master type devices and thus would typically be merely considered as being among connected I/O devices. However, in view of the increasing intelligence of all computer connected devices, the display and printer devices are shown as presented for completeness of description.

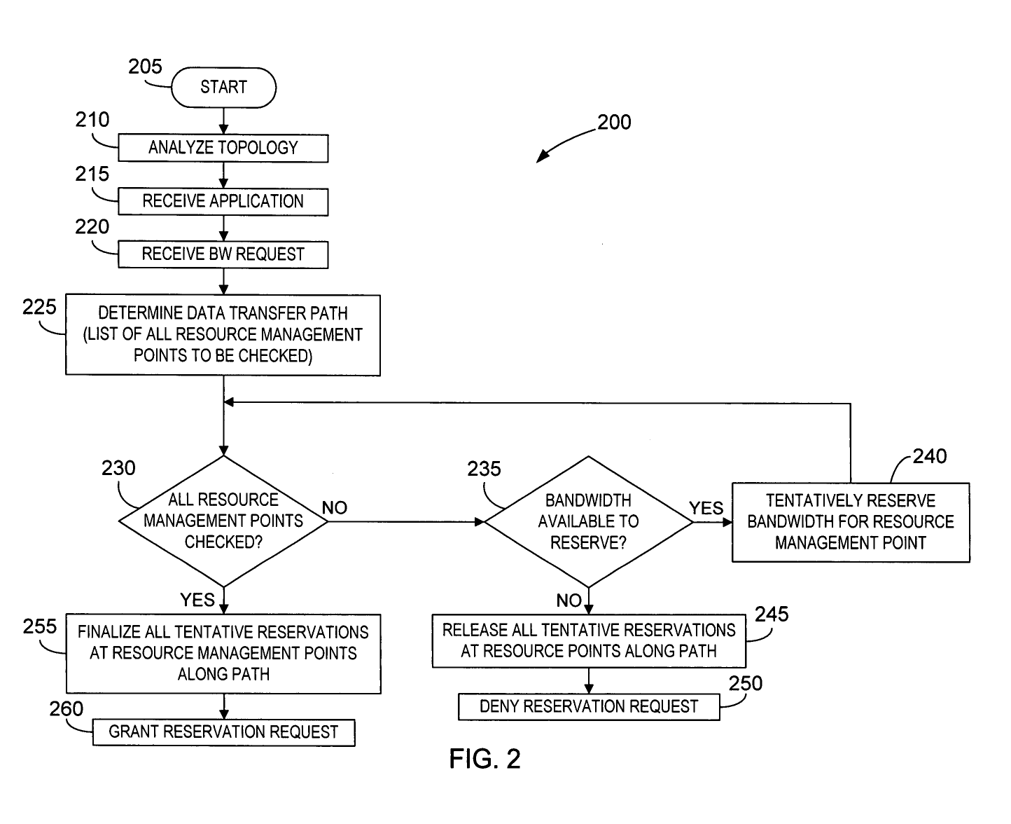

In FIG. 2, a flow diagram, indicative of actions taken within a portion of an OS used by the group of PUs in FIG. 1, starts with a block 205 and continues to a block 210 where the topology of the bus network of FIG. 1 is analyzed. In blocks 215 and 220, the operating system receives information about an application that wants to use bus 111 to transmit data to another device.

As an example, PU 105 may want to send instructions to PU 109 or may want to display information on a display 121. At some point, a BW (Bandwidth) request is received. The data transfer path is examined, as set forth in a block 225. If the bus is assumed to transfer data in a clockwise direction from a source to a destination, it will be apparent that more bus segment resources need to be checked when transferring data from PU 105 to printer 119 than when the transfer is only over the single bus segment from PU 105 to PU 107. The program determines in a decision block 230 whether or not all resource management points (bus segments) have been checked. If not, a check is made to determine if a given segment has bandwidth available to reserve in a decision block 235. This determination may be made from a BMT (Bandwidth Management Table) maintained by the OS. Such BMT is not specifically shown. If there is bandwidth available in the bus segment being checked, a reservation is tentatively assigned in a block 240 before returning to block 230 to check the next segment in the requested path.

On the other hand, if in block 235 it is determined that there is not sufficient BW available in a given bus segment being checked, the program releases all tentative reservations at bus segments or other resource points along the path as presented in block 245 and the request is denied as set forth in a block 250. When a determination is made in block 230 that all segments have been checked, the tentative reservations along the requested path are finalized and the reservation request is granted. This granting involves informing not only the requesting entity, such as an application within PU 105, but also the bus request queue manager 113 directly connected to the entity requesting the managed BW such as the previously mentioned PU 105.

As will be expanded upon later, the grant will include information as to when the bus request queue manager 113 may allow the requesting application to transmit data during each of a plurality of time frames. As an example, a time frame may comprise 1028 time slots where each time slot is sufficient to transmit 128 bytes of data. If an application requests and is granted the ability to transmit 512 bytes of data every time frame, the bus request queue manager 113 is informed that it can grant four time slots substantially evenly distributed over the time frame to the application uniquely identified in the grant.

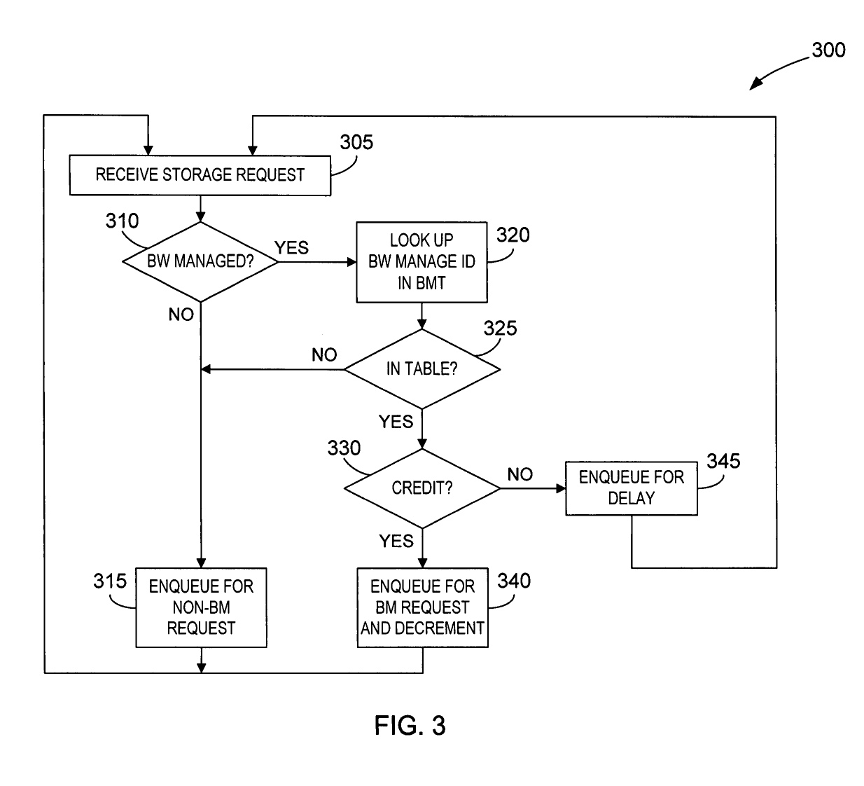

As shown in FIG. 3, a bus request queue manager 113 receives a request for at least temporarily storing data to be transmitted on the bus as shown in a block 305. This request is examined by a section of the bus request queue manager 113 that, for convenience in segregating it from prior art bus request queue managers, may be referred to as a load shaping section or simply load shaper 300. The load shaper, in a decision block 310, checks to see if the request is BW managed. That is, it is guaranteed space on the bus. If not, the request (and accompanying data to be transferred) is sent to a block 315 where it is enqueued to be transmitted on a “best effort space available” manner that has been used in prior art bus request queue managers. If in decision block 310, the load shaper ascertains that the request is of the type or class that is likely or apparently BW managed, a check is made, in a block 320, in a periodically updated BMT contained in the bus request queue manager 113. If, as shown in a decision block 325, a determination is made that the request for bus usage is not BW managed, the request is enqueued on a best efforts basis in previously detailed block 315. If, however, the entity making the request is listed in the BMT, a check is made, in a block 330, to determine if the entity has already used the BW allowed for the present time frame.

This check may be made by resetting a number of credits counter at the beginning of each time frame and decrementing the counter as each packet of data is enqueued or, alternatively, when it is transmitted or even again, alternatively, when a confirmation of receipt at the destination is obtained. In the example assumed above for a specific application, the credit would be four data packets per time frame. While a decremented counter is used in a preferred embodiment of the invention, many different usage tracking mechanisms may be implemented to accomplish this step or credit function.

Thus, if it is determined in block 330 that the application still has credit for another data packet to be transferred, the data packet will be enqueued for a BM (Bandwidth Managed) slot. If, on the other hand, all the credits for the time frame have been used (exhausted) by that application, the request is routed to a block 345 for delay until the next time frame when the application will have another four credits of data packets.

It should be mentioned that it would be undesirable to allocate all the time slots in a time frame to BM applications. A preferred embodiment of the invention used a maximum of 90 percent of the available time slots such that best efforts data packets had a reasonable chance of getting transmitted in a time acceptable to a user of the application.

To this point, the invention has been described as being applicable to a ring bus system. The invention is, however, applicable to any communication topology utilized by a multiplicity of devices and applications on a multiplexed basis. Examples of various bus topologies are ring, switch, multi-drop bus and mixed. It is thus intended that it be understood that the word “bus” is herein defined to include and refer to any communication topology utilized by a multiplicity of devices and applications in conjunction with a PU.

In summary, the load shaper of the present invention comprises software and/or hardware for giving priority, on an allocated basis, to data packet bus transmission requests from given entities. Typically the load shaper will interact with or be a part of a bus request queue manager. Some centralized control, such as the OS for a collection of devices sharing the common data transfer bus, will examine the request to determine if there is enough bandwidth presently available that is not already allocated to other BM entities. If there is sufficient available BW, the entity and allowed BW will be entered into a BMT for use by any load shaper in handling requests to data transmission on the bus. The load shaper includes a counting mechanism for each BM device or entity that may transmit managed data packets through a given bus request queue manager. This counting mechanism, in a preferred embodiment, is reset at the beginning of each time frame to a value coincident with the maximum number of data packets or time slots allowed in a given time frame for that entity. Any further requests for data packet transmission are delayed by the load shaper until the next time frame.

As indicated, unmanaged bus requests utilize time slots not otherwise allocated on a best efforts basis.

Although the invention has been described with reference to a specific embodiment, the description is not meant to be construed in a limiting sense. Various modifications of the disclosed embodiment, as well as alternative embodiments of the invention, will become apparent to persons skilled in the art upon reference to the description of the invention. It is therefore contemplated that the claims will cover any such modifications or embodiments that fall within the true scope and spirit of the invention.

1. Apparatus for providing distributed access control for load shaping in a computer system, comprising:
shaper means for comparing payload class against class restriction status to alternatively permit access of payload to transport network or to defer access; and
a credit allocation mechanism interconnected to said shaper means for allocating credits to class restriction status recorded in said shaper means.

2. A method of bus activity BW (Bandwidth) management in a computer system for use by a plurality of BW managed and BW unmanaged entities wishing to transmit data over said bus, comprising:
submitting a request, from a BW managed first entity, for a given bandwidth to an assignment entity;
returning an assigned unique identity and a designated allowable BW from said assignment entity to said first entity;
supplying said assigned unique identity and designated allowable BW from said assignment entity to a load shaping entity upon receipt, by said assignment entity, of acceptance of said BW by said first entity;
sending data packets from said first entity to said load shaping entity for transmission on a bus attended by said load shaping entity, each of said data packets providing class priority information including said unique identity;
reserving a number N of spaced apart time slots, commensurate with said designated BW, over a predetermined number of time slots, for use by said first entity for as long as said first entity continues to supply said data packets for transmission;
maintaining a count of data packets processed over said predetermined number of time slots to prevent said first entity from accessing the bus more than N times in said predetermined number of time slots;
resetting the count to a given value commensurate with N every predetermined number of time slots; and
permitting transmission of data packets over said bus by unmanaged entities when no managed BW entity data packets await transmission.

3. Shaper apparatus for use in connection with a bus request queue manager of a data transfer system, comprising:
a plurality of counter mechanisms each operable to maintain a count of remaining managed bus requests that are available for a given entity in a given operational period;
reset means for reinitializing each of said counter mechanisms each operational period;
table means for maintaining a record of entities authorized for managed data bus requests;
means for checking received bus requests against said table of entities authorized for managed data bus requests;
means for checking an appropriate counter mechanism assigned to the entity presently requesting bus access to determine if BW (Bandwidth) allocation authorized for said entity has already been used in the present operational period;
means for enqueueing the presently received bus request for transmission when the check of the counter mechanism provides an indication that the BW authorized for the present operational period has not already been used; and
means for enqueueing the presently received bus request for delay to a later operational period when the check of the counter mechanism provides an indication that the BW authorized for the present operational period has already been used.

4. Load shaper apparatus for use in connection with a multiplexed data transfer system, comprising:
a plurality of counter mechanisms each operable to maintain a count of remaining managed bus requests that are available for a given entity in a given operational period;
reset means for reinitializing each of said counter mechanisms each operational period;
first checking means operable to compare received bus requests with a list of entities authorized for managed data bus requests;
second checking means operable to access an appropriate counter mechanism assigned to the entity presently requesting bus access to determine if BW (Bandwidth) allocation authorized for said entity has already been used in the present operational period; and
storage means operable to enqueue the presently received bus request for transmission when the check of the counter mechanism provides an indication that the BW authorized for the present operational period has not already been used and alternatively operable to enqueue the presently received bus request for delay to a later operational period when the check of the counter mechanism provides an indication that the BW authorized for the present operational period has already been used.

5. Load shaper apparatus for use in connection with a multiplexed data transfer system, comprising:
a plurality of reset-able time slot allocation tracking mechanisms each operable to maintain a count of remaining managed bus requests that are available for a given entity in a given operational period and which are reinitialized each operational period;
comparison means operable to ascertain when received bus requests are authorized for managed data treatment;
checking means operable to access an appropriate allocation tracking mechanism assigned to the entity presently requesting bus access to determine if BW (Bandwidth) allocation authorized for said entity has already been used in the present operational period; and
means operable to enqueue the presently received bus request for transmission when the check of the counter mechanism provides an indication that the BW authorized for the present operational period has not already been used.

6. Shaper apparatus for multiplex communication path access control in a computer system, comprising:
segregation means for sending path use requests that are not presently authorized for managed access to a best effort queue; and
deferring means for preventing present access to said communication path of a given authorized managed access request when it is determined that a predetermined BW (Bandwidth) of data has already been transmitted over the path during a present operational period where different managed data requesters may have different authorized BW allocations.

7. Shaper apparatus for multiplex communication path access control in a computer system, comprising:
segregation means for removing path use requests that are presently authorized for managed access to a special queue; and
path access means operable to provide access to said communication path of a given authorized managed access request when it is determined that a predetermined BW (Bandwidth) of data has not already been transmitted over the path during a present operational period where different managed data requesters may have different authorized BW allocations.

8. A method of managing access to a multiplex communication path in a computer system, comprising:
removing path use requests that are presently authorized for managed access to a special queue; and
providing priority access to said communication path, of a given authorized managed access request, when it is determined that a predetermined BW (Bandwidth) of data has not already been transmitted over the path during a present operational period where different managed data requesters may have different authorized BW allocations.

9. A computer program product for managing access to a multiplex communication path in a computer system, the computer program product having a medium with a computer program embodied thereon, the computer program comprising:
computer code for removing path use requests that are presently authorized for managed access to a special queue; and
computer code for providing priority access to said communication path, of a given authorized managed access request, when it is determined that a predetermined BW (Bandwidth) of data has not already been transmitted over the path during a present operational period where different managed data requesters may have different authorized BW allocations.

10. A computer program product for managing bus activity BW (bandwidth) management in a computer system for use by a plurality of BW managed and BW unmanaged entities wishing to transmit data over said bus, the computer program product having a medium with a computer program embodied thereon, the computer program comprising:
computer code for submitting a request, from a BW managed first entity, for a given bandwidth to an assignment entity;
computer code for returning an assigned unique identity and a designated allowable BW from said assignment entity to said first entity;
computer code for supplying said assigned unique identity and designated allowable BW from said assignment entity to a load shaping entity upon receipt, by said assignment entity, of acceptance of said BW by said first entity;
computer code for sending data packets from said first entity to said load shaping entity for transmission on a bus attended by said load shaping entity, each of said data packets providing class priority information including said unique identity;
computer code for reserving a number N of spaced apart time slots commensurate with said designated BW, over a predetermined number of time slots, for use by said first entity for as long as said first entity continues to supply said data packets for transmission;
computer code for maintaining a count of data packets processed over said predetermined number of time slots to prevent said first entity from accessing the bus more than N times in said predetermined number of time slots;
computer code for resetting the count to a given value commensurate with N every predetermined number of time slots; and
computer code for permitting transmission of data packets over said bus by unmanaged entities when no managed BW entity data packets await transmission.

11. A method of queuing data packets for transmission from a source to a target over a multiplexed communication path, comprising:
checking received data packets to ascertain whether they belong to a managed class;
placing data packets in a first queue for transmission on a best efforts basis;
checking remaining data packets ascertained to be in a managed class to determine if they originate from a source that is presently authorized to be managed;
placing data packets, determined to have no present authorization to be managed, in said first queue for transmission on a best efforts basis;
checking remaining data packets, determined to presently be authorized for management, to ascertain if BW (Bandwidth) authorized for the source of the data packets has been exceeded for the present operational time period; and
placing data packets, determined to have present authorization to be managed and to have BW remaining in the present operational time period in a second queue unique to that class source of data, said second queue having priority over said first queue.

12. The method of claim 11, comprising, in addition:
placing data packets, determined to have present authorization to be managed and to have no BW remaining in the present operational time period in a delay queue for transmission in a later time period.

13. The method of claim 11, comprising, in addition:
maintaining a count of the number of managed data packets transmitted by a given presently authorized managed data source in a given operational time period as a way of ascertaining BW; and
reinitializing the count each operational time period.

14. Apparatus for selectively queuing data packets for transmission from a source to targets over a multiplexed communication path, comprising:
means for checking received data packets to ascertain whether they belong to a managed class;
means for placing data packets in a first queue for transmission on a best efforts basis;
means for checking remaining data packets ascertained to be in a managed class to determine if they originate from a source that is presently authorized to be managed;
means for placing data packets, determined to have no present authorization to be managed, in said first queue for transmission on a best efforts basis;
means for checking remaining data packets, determined to presently be authorized for management, to ascertain if BW (Bandwidth) authorized for the source of the data packets has been exceeded for the present operational time period; and
means for placing data packets, determined to have present authorization to be managed and to have BW remaining in the present operational time period, in a second queue unique to that class source of data, said second queue having priority over said first queue.
